(19) United States
(12) Patent Application Publication
(10) Pub. No.: US 2021/0385903 A1
(43) Pub. Date: Dec. 9, 2021

(54) User-Equipment-Initiated Cancelation of a Base Station Downlink Transmission

(71) Applicant: Google LLC, Mountain View, CA (US)

(72) Inventors: Jibing Wang, San Jose, CA (US); Erik Richard Stauffer, Sunnyvale, CA (US)

(73) Assignee: Google LLC, Mountain View, CA (US)

(21) Appl. No.: 17/287,898

(22) PCT Filed: Nov. 27, 2019
(86) PCT No.: PCT/US2019/063620

§ 371 Date: Apr. 22, 2021

Related U.S. Application Data
(60) Provisional application No. 62/772,011, filed on Nov. 27, 2018.

(51) Int. Cl. H04W 76/34; H04W 72/14; H04W 72/12; H04W 72/04; H04W 52/02

(52) U.S. Cl. CPC H04W 76/34; H04W 72/14; H04W 72/1273; H04W 52/0238; H04W 72/046; H04W 52/0277; H04W 72/042

(57) ABSTRACT

This document describes techniques and systems that enable user-equipment-initiated cancelation of a base station downlink transmission. The techniques and systems allow a user equipment (UE) to generate a downlink transmission cancelation request (DTCR) and send the DTCR to a base station to cancel or suspend an ongoing or scheduled downlink (DL) transmission from the base station. The UE can detect trigger events that can indicate that the DL transmission should be canceled or suspended. The UE can transmit the DTCR to the base station using a variety of techniques, including a physical uplink shared channel transmission or using a physical uplink control channel operation. These techniques allow the UE to cancel or suspend a DL transmission during the transmission or prior to a scheduled transmission, which can enable the UE to quickly mitigate adverse operating conditions such as excessive RF interference or low battery capacity.

### BACKGROUND

The evolution of wireless communication to fifth generation (5G) standards and technologies provides higher data rates and greater capacity, with improved reliability and lower latency, which enhances mobile broadband services. 5G technologies also provide new classes of services for vehicular networking, fixed wireless broadband, and the Internet of Things (IoT).

A unified air interface, which utilizes licensed, unlicensed, and shared license radio spectrum in multiple frequency bands, is one aspect of enabling the capabilities of 5G systems. The 5G air interface utilizes radio spectrum in bands below 1 GHz (sub-gigahertz), below 6 GHz (sub-6 GHz), and above 6 GHz. Radio spectrum above 6 GHz includes millimeter wave (mmWave) frequency bands that provide wide channel bandwidths to support higher data rates for wireless broadband. Another aspect of enabling the capabilities of 5G systems is the use of Multiple Input Multiple Output (MIMO) antenna systems to beamform signals transmitted between base stations and user equipment to increase the capacity of 5G radio networks.

A 5G network may be implemented as a high-density network in which each base station or cell serves fewer users than in conventional, pre-5G networks. Many of these users, however, are expected to operate their 5G user equipment with higher data rate requirements and increased capacity requests, and the 5G base stations will be expected to support a wide variety of services at one time, with different downlink (DL) and uplink (UL) demands. Some conventional techniques for managing this varying demand for uplink and downlink traffic may rely on techniques such as dynamic time division duplex (TDD) technology to improve efficiency by dynamically changing transmission direction between UL and DL. While these techniques can be effective in managing the variation in UL and DL demand, they can also introduce radio frequency (RF) interference, which can lead to significant performance degradation, including disconnection and reduced data throughput.

### SUMMARY

This document describes techniques and systems that enable user-equipment-initiated cancelation of a base station downlink transmission. The techniques and systems allow a user equipment to send a downlink transmission cancelation request (DTCR) to a base station to cancel or suspend an ongoing or scheduled downlink (DL) transmission from the base station. The user equipment can detect trigger events that can indicate that the DL transmission should be canceled or suspended. The user equipment can transmit the DTCR to the base station using a variety of techniques, including a physical uplink shared channel (PUSCH) transmission or using a physical uplink control channel (PUCCH) operation. These techniques allow the user equipment to cancel or suspend a DL transmission during the transmission or prior to a scheduled transmission, which can enable the user equipment to quickly mitigate adverse operating conditions such as excessive radio frequency (RF) interference, low battery capacity, or excessive temperature.

In some aspects, a method for canceling a downlink transmission for a user equipment (UE) is described. The method comprises detecting, by the UE while in a connected mode, a trigger event and, in response to the trigger event, generating a downlink transmission cancelation request (DTCR), the DTCR including a downlink transmission identification field value that corresponds to the downlink transmission. The method further includes transmitting the DTCR to a base station from which the downlink transmission is received, the transmitting being effective to direct the base station to cancel the downlink transmission that is described in the DTCR. The method further includes maintaining the UE in the connected mode responsive to the downlink transmission being canceled.

In further aspects, a user equipment (UE) is described that includes a radio frequency (RF) transceiver and a processor and memory system to implement a downlink transmission cancelation (DTC) manager application. The DTC manager application is configured to detect a trigger event while the UE is in a connected mode and, in response to the trigger event, generate a downlink transmission cancelation request (DTCR), the DTCR including a downlink transmission identification field value that corresponds to the downlink transmission. Further, the DTC manager application uses the RF transceiver to transmit the DTCR to a base station from which the downlink transmission is received by the UE, and the transmitting of the DTCR is effective to direct the base station to cancel the downlink transmission described in the DTCR. Further, the DTC manager application can maintain the UE in the connected mode responsive to the downlink transmission being canceled.

In further aspects, a user equipment (UE) is described that includes a radio frequency (RF) transceiver and a processor and memory system to implement a first means that can be used to detect a trigger event while the UE is in a connected mode and, in response to the trigger event, generate a second means that identifies a downlink transmission, from a base station, that is to be canceled. Further, the first means can transmit the second means to the base station that is providing the identified downlink transmission, which directs the base station to cancel the identified downlink transmission. The first means can also maintain the UE in the connected mode responsive to the downlink transmission being canceled.

This summary is provided to introduce simplified concepts of user-equipment-initiated cancelation of a base station downlink transmission. The simplified concepts are further described below in the Detailed Description. This summary is not intended to identify essential features of the claimed subject matter, nor is it intended for use in determining the scope of the claimed subject matter.

### BRIEF DESCRIPTION OF THE DRAWINGS

Aspects of user-equipment-initiated cancelation of a base station downlink transmission are described with reference to the following drawings. The same numbers are used throughout the drawings to reference like features and components:

FIG. 1 illustrates an example environment in which various aspects of user-equipment-initiated cancelation of a base station downlink transmission can be implemented.

FIG. 2 illustrates an example device diagram of a user equipment and a base station that can implement various aspects of user-equipment-initiated cancelation of a base station downlink transmission.

FIG. 3 illustrates an example block diagram of a wireless network stack model in which various aspects of user-equipment-initiated cancelation of a base station downlink transmission can be implemented.

FIG. 4 illustrates examples of the resource control states described in FIG. 3.

FIG. 5 illustrates an air interface resource that extends between a user equipment and a base station and with which various aspects of user-equipment-initiated cancelation of a base station downlink transmission can be implemented.

FIG. 6 illustrates an example environment in which aspects of user-equipment-initiated cancelation of a base station downlink transmission can detect RF interference and cancel a DL transmission that is being affected by the RF interference.

FIG. 7 illustrates an example method for user-equipment-initiated cancelation of a base station downlink transmission as generally related to techniques that allow a user equipment to cancel a DL transmission, in accordance with aspects of the techniques described herein.

### DETAILED DESCRIPTION

Overview

This document describes techniques using, and devices enabling, user-equipment-initiated cancelation of a base station downlink transmission. As noted, a fifth-generation new radio (5G) network can be implemented as a high-density network that can provide a wide variety of services at one time, with varying downlink (DL) and uplink (UL) demands. The 5G network may use techniques such as dynamic time division duplex (TDD) technology to improve efficiency by dynamically changing transmission direction between UL and DL. These conventional techniques, however, can also introduce radio frequency (RF) interference (e.g., between a user equipment in an UL mode and another user equipment in a DL mode), which can lead to significant performance degradation, including disconnection and reduced data throughput. Further, the interference related to some conventional techniques, such as TDD, may lead to situations in which the user equipment is allocated network resources that it cannot effectively use (because of the interference), which could be allocated to, and put to use by, other user equipment.

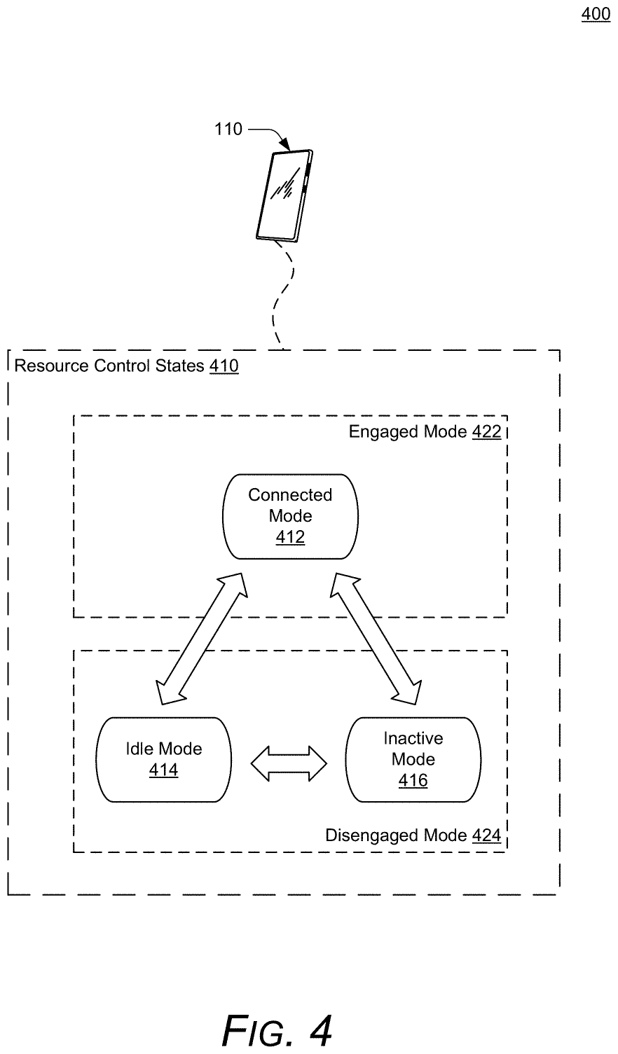

In contrast, the described techniques allow a user equipment to generate and transmit a downlink transmission cancelation request (DTCR) that can be used to cancel or suspend a specific current or scheduled DL transmission from a base station. For clarity, the term “cancel,” as used in this document with reference to a radio connection or downlink transmission, should be understood to include any one or more of cancel, release, or suspend. Based on the DTCR, the base station cancels the DL transmission specified by the DTCR. The user equipment may transmit the DTCR to the base station in response to a trigger event, such as excessive RF interference (e.g., RF interference between nearby user equipments), a battery-capacity issue, or a thermal or temperature issue. The trigger event may be detected (e.g., by the user equipment or another device) while the user equipment is in an engaged or disengaged mode. Additional details of the engaged and disengaged modes are described with reference to FIG. 4.

For example, an RF-interference-based trigger event can be an RF noise level that exceeds a threshold (e.g., RF noise in a frequency or frequency band near the frequency of the DL transmission that exceeds a noise threshold). Another RF-related trigger event can be a signal-to-noise (SNR) ratio, or a signal-to-artificial-noise ratio (SANR), for the DL transmission transmitted to the user equipment that falls below a threshold value (e.g., an SNR or SANR of less than 15 dB, less than 20 dB, or less than 25 dB). Similarly, a battery-capacity trigger event can be a remaining battery-capacity level falling below a capacity threshold, and a thermal trigger event can be a value of a thermal parameter of the user equipment exceeding a thermal threshold.

The DTCR can be transmitted to the base station using a variety of lower layer connections, including a grantless physical uplink shared channel (PUSCH) transmission, a physical uplink control channel (PUCCH) operation, or Radio Resource Control (RRC) signaling. Thus, the user equipment can take advantage of the DTCR to cancel a DL transmission in response to a trigger event, either during an ongoing DL transmission or prior to a scheduled DL transmission. In this way, the user equipment can address interference issues, thermal issues, and battery-capacity challenges, while conserving network resources that can be used by other devices on the network. Further, by enabling a user equipment to cancel a downlink transmission, network efficiency can be improved by using information that is known only by the user equipment (e.g., an SNR or SANR measured at the user equipment, a battery capacity level and/or a thermal parameter of the user equipment) to prevent unnecessary downlink transmissions.

Consider, for example, a user equipment that detects interference from another nearby user equipment during a DL transmission. As the user equipment continues to operate with the interference, its performance may be degraded and some data may be lost. In contrast, using the described techniques, the user equipment can transmit the DTCR to the base station and cancel the DL transmission until the interference issue is resolved. This can improve network efficiency and conserve network resources, as well as preserve battery capacity and allow the user equipment to operate longer.

While features and concepts of the described systems and methods for user-equipment-initiated cancelation of a base station downlink transmission can be implemented in any number of different environments, systems, devices, and/or various configurations, aspects of user-equipment-initiated cancelation of a base station downlink transmission are described in the context of the following example devices, systems, and configurations.

Example Environment

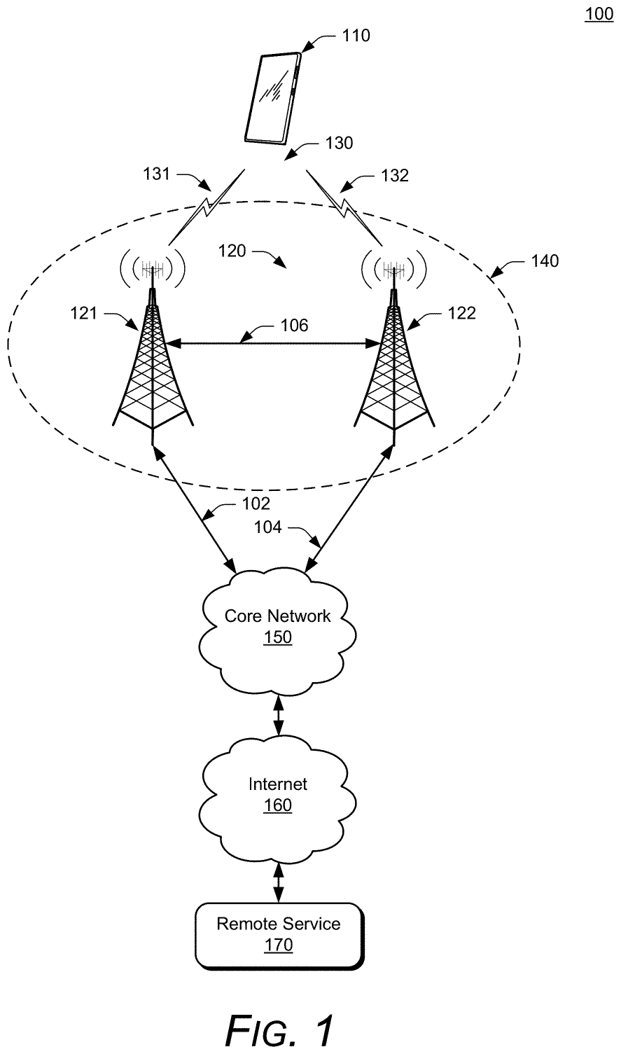

FIG. 1 illustrates an example environment 100 in which various aspects of user-equipment-initiated cancelation of a base station downlink transmission can be implemented. The example environment 100 includes a user equipment 110 that communicates with one or more base stations 120 (illustrated as base stations 121 and 122), through one or more wireless communication links 130 (wireless link 130), illustrated as wireless links 131 and 132. For simplicity, the user equipment 110 is implemented as a smartphone but may be implemented as any suitable computing or electronic device, such as a mobile communication device, modem, cellular phone, gaming device, navigation device, media device, laptop computer, desktop computer, tablet computer, smart appliance, vehicle-based communication system, or an Internet-of-Things (IoT) device such as a sensor or an actuator. The base stations 120 (e.g., an Evolved Universal Terrestrial Radio Access Network Node B, E-UTRAN Node B, evolved Node B, eNodeB, eNB, Next Generation Node B, gNode B, gNB, ng-eNB, or the like) may be implemented in a macrocell, microcell, small cell, picocell, and the like, or any combination thereof.

The base stations 120 communicate with the user equipment 110 using the wireless links 131 and 132, which can be implemented as any suitable type of wireless link. The wireless links 131 and 132 can include control and data communication, such as downlink of data and control information communicated from the base stations 120 to the user equipment 110, uplink of other data and control information communicated from the user equipment 110 to the base stations 120, or both. The wireless links 130 may include one or more wireless links (e.g., radio links) or bearers implemented using any suitable communication protocol or standard, or combination of communication protocols or standards such as 3rd Generation Partnership Project Long-Term Evolution (3GPP LTE), Fifth Generation New Radio (5G NR), and so forth. Multiple wireless links 130 may be aggregated in a carrier aggregation to provide a higher data rate for the user equipment 110. Multiple wireless links 130 from multiple base stations 120 may be configured for Coordinated Multipoint (CoMP) communication with the user equipment 110.

The base stations 120 are collectively a Radio Access Network 140 (e.g., RAN, Evolved Universal Terrestrial Radio Access Network, E-UTRAN, 5G NR RAN, or NR RAN). The base stations 121 and 122 in the RAN 140 are connected to a core network 150. The base stations 121 and 122 connect, at 102 and 104 respectively, to the core network 150 through an NG2 interface for control-plane signaling and using an NG3 interface for user-plane data communications when connecting to a 5G core network, or using an Si interface for control-plane signaling and user-plane data communications when connecting to an Evolved Packet Core (EPC) network. The base stations 121 and 122 can communicate using an Xn Application Protocol (XnAP) through an Xn interface, or using an X2 Application Protocol (X2AP) through an X2 interface, at 106, to exchange user-plane and control-plane data. The user equipment 110 may connect, using the core network 150, to public networks, such as the Internet 160 to interact with a remote service 170.

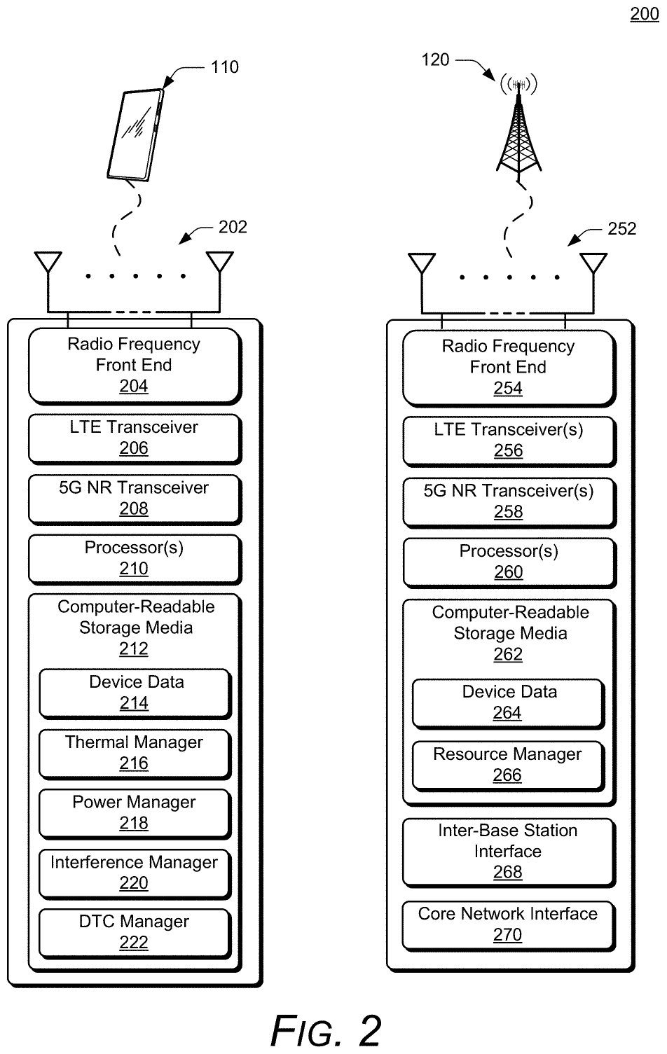

FIG. 2 illustrates an example device diagram 200 of the user equipment 110 and the base stations 120. The user equipment 110 and the base stations 120 may include additional functions and interfaces that are omitted from FIG. 2 for the sake of clarity. The user equipment 110 includes antennas 202, a radio frequency front end 204 (RF front end 204), an LTE transceiver 206, and a 5G NR transceiver 208 for communicating with base stations 120 in the RAN 140. The RF front end 204 of the user equipment 110 can couple or connect the LTE transceiver 206, and the 5G NR transceiver 208 to the antennas 202 to facilitate various types of wireless communication. The antennas 202 of the user equipment 110 may include an array of multiple antennas that are configured similarly to, or differently from, each other. The antennas 202 and the RF front end 204 can be tuned to, and/or be tunable to, one or more frequency bands defined by the 3GPP LTE and 5G NR communication standards and implemented by the LTE transceiver 206, and/or the 5GNR transceiver 208. Additionally, the antennas 202, the RF front end 204, the LTE transceiver 206, and/or the 5GNR transceiver 208 can be configured to support beamforming for the transmission and reception of communications with the base stations 120. By way of example and not limitation, the antennas 202 and the RF front end 204 can be implemented for operation in sub-gigahertz bands, sub-6 GHz bands, and/or above 6 GHz bands that are defined by the 3GPP LTE and 5G NR communication standards.

The user equipment 110 also includes processor(s) 210 and computer-readable storage media 212 (CRM 212). The processor 210 can have a single-core processor or multiple core processors composed of a variety of materials, such as silicon, polysilicon, high-K dielectric, copper, and so on. The computer-readable storage media described herein excludes propagating signals. CRM 212 may include any suitable memory or storage device such as random-access memory (RAM), static RAM (SRAM), dynamic RAM (DRAM), non-volatile RAM (NVRAM), read-only memory (ROM), or Flash memory useable to store device data 214 of the user equipment 110. The device data 214 includes user data, multimedia data, beamforming codebooks, applications, and/or an operating system of the user equipment 110, which are executable by processor(s) 210 to enable user-plane communication, control-plane signaling, and user interaction with the user equipment 110.

In some implementations, the CRM 212 may also include one or more of a thermal manager 216, a power manager 218, or a radio-frequency interference manager 220 (interference manager 220). The thermal manager 216 can communicate with one or more thermal sensors (e.g., a thermistor or other temperature or heat sensor), included or associated with the user equipment 110, which measure temperature and other thermal properties of the user equipment 110 (including individual measurements of various components of the user equipment 110). The thermal manager 216 can store and transmit values of the measurements to other components of the user equipment 110 or to other devices. The power manager 218 can monitor a battery (or batteries) of the user equipment 110. The power manager 218 can also measure, store, and communicate values of various power-related parameters of the user equipment 110 (e.g., remaining battery capacity) to other components of the user equipment 110 or to other devices.

The interference manager 220 can communicate with one or more RF-signal detectors (not shown in FIG. 2), which can detect RF signals that may interfere with transmissions between the user equipment 110 and the base stations 120 (e.g., an RF jammer detector, an RF sniffer, or another RF-signal detector). The RF-signal detector can be part of, or separate from, the user equipment 110 (e.g., a component of the user equipment 110 or a separate component that can communicate with the user equipment 110). The interference manager 220 can also store and transmit information, related to RF interference, to other components of the user equipment 110 or to other devices. Further, while shown as part of the CRM 212 in FIG. 2, any one or more of the thermal manager 216, the power manager 218, or the interference manager 220 can be implemented in whole or part as hardware logic or circuitry integrated with or separate from other components of the user equipment 110.

CRM 212 may also include a downlink transmission cancelation (DTC) manager 222. Alternatively or additionally, the DTC manager 222 can be implemented in whole or part as hardware logic or circuitry integrated with or separate from other components of the user equipment 110. In at least some aspects, the DTC manager 222 configures the RF front end 204, the LTE transceiver 206, and/or the 5G NR transceiver 208 to implement the techniques for user-equipment-initiated cancelation of a base station downlink transmission described herein.

For example, the DTC manager 222 can detect a trigger event and, in response to the trigger event, generate a downlink transmission cancelation request (DTCR) that includes a request to cancel a particular DL transmission from the base stations 120 (the DTCR is described with additional detail below). The DL transmission described or specified in the DTCR can be a currently ongoing DL transmission or a scheduled DL transmission that is already granted. In some cases, the DTC manager 222 may detect the trigger event by communicating with one or more of the thermal manager 216, the power manager 218, or the interference manager 220. Further, the DTC manager 222 may also transmit the DTCR to the base stations 120 (e.g., to the one or more base stations providing the DL transmission that is to be canceled) and direct the base stations 120 to cancel the particular DL transmission that is described in the DTCR.

The device diagram for the base stations 120, shown in FIG. 2, includes a single network node (e.g., a gNode B). The functionality of the base stations 120 can be distributed across multiple network nodes or devices and can be distributed in any fashion suitable to perform the functions described herein. The base stations 120 include antennas 252, a radio frequency front end 254 (RF front end 254), one or more LTE transceivers 256, and/or one or more 5G NR transceivers 258 for communicating with the user equipment 110. The RF front end 254 of the base stations 120 can couple or connect the LTE transceivers 256 and the 5G NR transceivers 258 to the antennas 252 to facilitate various types of wireless communication. The antennas 252 of the base stations 120 may include an array of multiple antennas that are configured similarly to, or differently from, each other. The antennas 252 and the RF front end 254 can be tuned to, and/or be tunable to, one or more frequency bands defined by the 3GPP LTE and 5G NR communication standards, and implemented by the LTE transceivers 256, and/or the 5G NR transceivers 258. Additionally, the antennas 252, the RF front end 254, the LTE transceivers 256, and/or the 5G NR transceivers 258 can be configured to support beamforming, such as Massive-MIMO, for the transmission and reception of communications with the user equipment 110.

The base stations 120 also include processor(s) 260 and computer-readable storage media 262 (CRM 262). The processor 260 can have a single-core processor or multiple core processors composed of a variety of materials, such as silicon, polysilicon, high-K dielectric, copper, and so on. CRM 262 may include any suitable memory or storage device such as random-access memory (RAM), static RAM (SRAM), dynamic RAM (DRAM), non-volatile RAM (NVRAM), read-only memory (ROM), or Flash memory useable to store device data 264 of the base stations 120. The CRM 262 may exclude propagating signals. The device data 264 includes network scheduling data, radio resource management data, beamforming codebooks, applications, and/or an operating system of the base stations 120, which are executable by processor(s) 260 to enable communication with the user equipment 110.

CRM 262 also includes a resource manager 266. Alternatively or additionally, the resource manager 266 can be implemented in whole or part as hardware logic or circuitry integrated with or separate from other components of the base stations 120. In at least some aspects, the resource manager 266 configures the LTE transceivers 256 and the 5G NR transceivers 258 for communication with the user equipment 110, as well as communication with a core network, such as the core network 150. Additionally, the resource manager 266 may perform one or both of managing or scheduling DL transmissions to the user equipment 110. The resource manager 266 may also receive the DTCR from the user equipment 110. Based at least in part on the DTCR, the resource manager 266 may determine DL transmission that is to be canceled and cancel the determined DL transmission.

The base stations 120 may also include an inter-base station interface 268, such as an Xn and/or X2 interface, which the resource manager 266 configures to exchange user-plane and control-plane data between other base stations 120, to manage the communication of the base stations 120 with the user equipment 110. The base stations 120 also include a core network interface 270 that the resource manager 266 configures to exchange user-plane and control-plane data with core network functions and entities.

User-Plane and Control-Plane Signaling

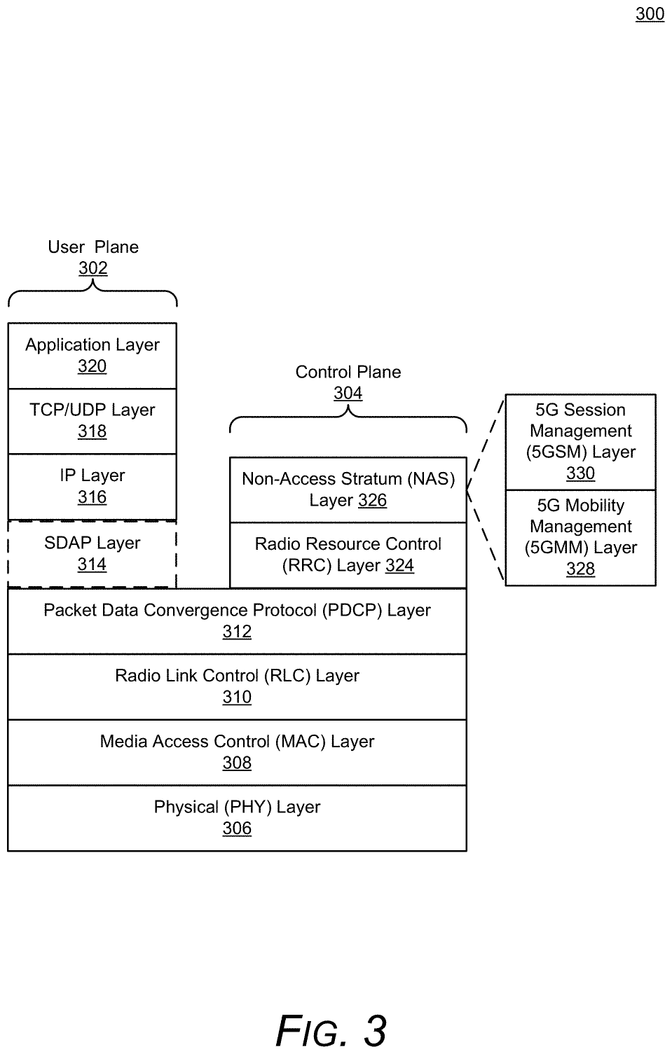

FIG. 3 illustrates an example block diagram 300 of a wireless network stack model 300 (stack 300). The stack 300 characterizes a communication system for the example environment 100, in which various aspects of user-equipment-initiated cancelation of a base station downlink transmission can be implemented. The stack 300 includes a user plane 302 and a control plane 304. Upper layers of the user plane 302 and the control plane 304 share common lower layers in the stack 300. Wireless devices, such as the user equipment 110 or the base station 120, implement each layer as an entity for communication with another device using the protocols defined for the layer. For example, a user equipment 110 uses a Packet Data Convergence Protocol (PDCP) entity to communicate to a peer PDCP entity in a base station 120 using the PDCP.

The shared lower layers include a physical (PHY) layer 306, a Media Access Control (MAC) layer 308, a Radio Link Control (RLC) layer 310, and a PDCP layer 312. The PHY layer 306 provides hardware specifications for devices that communicate with each other. As such, the PHY layer 306 establishes how devices connect to each other, assists in managing how communication resources are shared among devices, and the like.

The MAC layer 308 specifies how data is transferred between devices. Generally, the MAC layer 308 provides a way in which data packets being transmitted are encoded and decoded into bits as part of a transmission protocol.

The RLC layer 310 provides data transfer services to higher layers in the stack 300. Generally, the RLC layer 310 provides error correction, packet segmentation and reassembly, and management of data transfers in various modes, such as acknowledged, unacknowledged, or transparent modes.

The PDCP layer 312 provides data transfer services to higher layers in the stack 300. Generally, the PDCP layer 312 provides transfer of user plane 302 and control plane 304 data, header compression, ciphering, and integrity protection.

Above the PDCP layer 312, the stack splits into the user-plane 302 and the control-plane 304. Layers of the user plane 302 include an optional Service Data Adaptation Protocol (SDAP) layer 314, an Internet Protocol (IP) layer 316, a Transmission Control Protocol/User Datagram Protocol (TCP/UDP) layer 318, and an application layer 320, which transfers data using the wireless link 106. The optional SDAP layer 314 is present in 5G NR networks. The SDAP layer 314 maps a Quality of Service (QoS) flow for each data radio bearer and marks QoS flow identifiers in uplink and downlink data packets for each packet data session. The IP layer 316 specifies how the data from the application layer 320 is transferred to a destination node. The TCP/UDP layer 318 is used to verify that data packets intended to be transferred to the destination node reached the destination node, using either TCP or UDP for data transfers by the application layer 320. In some implementations, the user plane 302 may also include a data services layer (not shown) that provides data transport services to transport application data, such as IP packets including web-browsing content, video content, image content, audio content, or social media content.

The control plane 304 includes a Radio Resource Control (RRC) layer 324 and a Non-Access Stratum (NAS) layer 326. The RRC layer 324 establishes and releases connections and radio bearers, broadcasts system information, or performs power control. The RRC layer 324 also controls a resource control state of the user equipment 110 and directs the user equipment 110 to perform operations according to the resource control state. Example resource control states include an engaged mode or a disengaged mode. In general, if the user equipment 110 is in the engaged mode, the connection with the base station 120 is active. In the disengaged mode, the connection with the base station 120 is suspended or released. Generally, the RRC layer 324 supports 3GPP access but does not support non-3GPP access (e.g., WLAN communications).

Consider FIG. 4, which illustrates example resource control states with additional detail. Generally, a wireless network operator provides its telecommunication services to user equipment through a wireless network. To communicate wirelessly with the network, a user equipment 110 utilizes an RRC procedure to establish a connection to the network using a cell (e.g., the base station, a serving cell). Upon establishing the connection to the network using the base stations 120, the user equipment 110 enters a connected mode (e.g., RRC-connected mode, RRC CONNECTED state, NR-RRC CONNECTED state, or E-UTRA RRC CONNECTED state).

The user equipment 110 operates according to different resource control states 410. Different situations may occur that cause the user equipment 110 to transition between different resource control states 410 as determined by the radio access technology. Example resource control states 410 illustrated in FIG. 4 include a connected mode 412, an idle mode 414, and an inactive mode 416. A user equipment 110 is either in the connected mode 412 or in the inactive mode 416 when an RRC connection is active. If an RRC connection is not active, then the user equipment 110 is in the idle mode 414.

In establishing the RRC connection, the user equipment 110 may transition from the idle mode 414 to the connected mode 412. After establishing the connection, the user equipment 110 may transition (e.g., upon connection inactivation) from the connected mode 412 to an inactive mode 416 (e.g., RRC-inactive mode, RRC INACTIVE state, NR-RRC INACTIVE state) and the user equipment 110 may transition (e.g., using an RRC connection resume procedure) from the inactive mode 416 to the connected mode 412. After establishing the connection, the user equipment 110 may transition between the connected mode 412 to an idle mode 414 (e.g., RRC-idle mode, RRC_IDLE state, NR-RRC-IDLE state, E-UTRA RRC IDLE state), for instance upon the network releasing the RRC connection. Further, the user equipment 110 may transition between the inactive mode 416 and the idle mode 414.

Further, the user equipment 110 may be in an engaged mode 422 or may be in a disengaged mode 424. As used herein, an engaged mode 422 is a connected mode (e.g., connected mode 412) and a disengaged mode 424 is an idle, disconnected, connected-but-inactive, connected-but-dormant mode (e.g., idle mode 414, inactive mode 416). In some cases, in the disengaged mode 424, the user equipment 110 may still be registered at a Non-Access Stratum (NAS) layer with radio bearer active (e.g., inactive mode 416).

Each of the different resource control states 410 may have different quantities or types of resources available, which may affect power consumption within the user equipment 110. In general, the connected mode 412 represents the user equipment 110 actively connected to (engaged with) the base stations 120. In the inactive mode 416, the user equipment 110 suspends connectivity with the base station 120 and retains information that enables connectivity with the base station 120 to be quickly re-established. In the idle mode 414, the user equipment 110 releases the connection with the base stations 120. Thus, the inactive mode 416 enables the user equipment to use less power (e.g., compared with the connected mode 412) but reduces latency when reconnecting (e.g., compared with the idle mode 414).

Some of the resource control states 410 may be limited to certain radio access technologies. For example, the inactive mode 416 may be supported in LTE Release 15 (eLTE) and 5G NR, but not in 3G or previous generations of 4G standards. Other resource control states may be common or compatible across multiple radio access technologies, such as the connected mode 412 or the idle mode 414.

Returning to FIG. 3, the NAS layer 326 provides support for mobility management (e.g., using a Fifth-Generation Mobility Management (SGMM) layer 328) and packet data bearer contexts (e.g., using a Fifth-Generation Session Management (SGSM) layer 330) between the user equipment 110 and entities or functions in the core network, such as an Access and Mobility Management Function (AMF) of the 5GC 150 or the like. The AMF provides control-plane functions, such as registration and authentication of multiple user equipment 110, authorization, and mobility management in the 5G NR network. The AMF communicates with the base stations 120 in the RANs 140 and can use the base stations 120 to communicate with multiple user equipments 110. The NAS layer 326 supports both 3GPP access and non-3GPP access.

In the user equipment 110, each layer in both the user plane 302 and the control plane 304 of the stack 300 interacts with a corresponding peer layer or entity in the base station 120, a core network entity or function, and/or a remote service, to support user applications and control operation of the user equipment 110 in the RAN 140.

Air Interface Resources

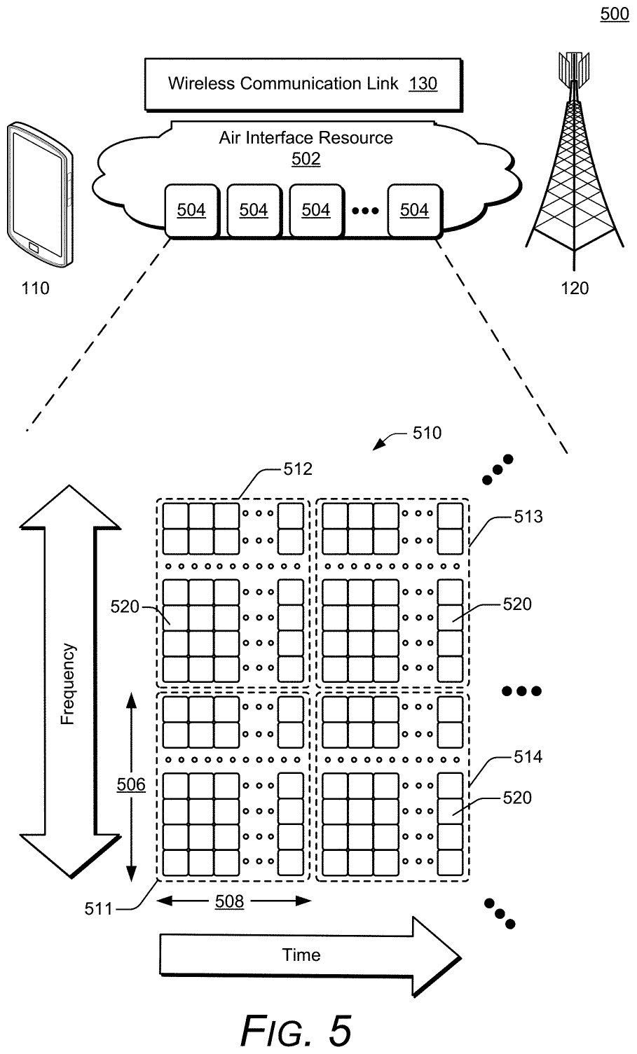

FIG. 5 generally illustrates at 500, an air interface resource that extends between a user equipment and a base station and with which various aspects of user-equipment-initiated cancelation of a base station downlink transmission can be implemented. The air interface resource 502 can be divided into resource units 504, each of which occupies some intersection of frequency spectrum and elapsed time. A portion of the air interface resource 502 is illustrated graphically in a grid or matrix having multiple resource blocks 510, including example resource blocks 511, 512, 513, 514. An example of a resource unit 504 therefore includes at least one resource block 510. As shown, time is depicted along the horizontal dimension as the abscissa axis, and frequency is depicted along the vertical dimension as the ordinate axis. The air interface resource 502, as defined by a given communication protocol or standard, may span any suitable specified frequency range, and/or may be divided into intervals of any specified duration. Increments of time can correspond to, for example, milliseconds (mSec). Increments of frequency can correspond to, for example, megahertz (MHz).

In example operations generally, the base stations 120 allocate portions (e.g., resource units 504) of the air interface resource 502 for uplink and downlink communications. Each resource block 510 of network access resources can be allocated to support respective wireless communication links 130 of multiple user equipment 110. In the lower left corner of the grid, the resource block 511 may span, as defined by a given communication protocol, a specified frequency range 506 and comprise multiple subcarriers or frequency sub-bands. The resource block 511 may include any suitable number of subcarriers (e.g., 12) that each correspond to a respective portion (e.g., 15 kHz) of the specified frequency range 506 (e.g., 180 kHz). The resource block 511 may also span, as defined by the given communication protocol, a specified time interval 508 or time slot (e.g., lasting approximately one-half millisecond or 7 orthogonal frequency-division multiplexing (OFDM) symbols). The time interval 508 includes subintervals that may each correspond to a symbol, such as an OFDM symbol. As shown in FIG. 5, each resource block 510 may include multiple resource elements 520 (REs) that correspond to, or are defined by, a subcarrier of the frequency range 506 and a subinterval (or symbol) of the time interval 508. Alternatively, a given resource element 520 may span more than one frequency subcarrier or symbol. Thus, a resource unit 504 may include at least one resource block 510, at least one resource element 520, and so forth.

In example implementations, multiple user equipment 110 (one of which is shown) are communicating with the base stations 120 (one of which is shown) through access provided by portions of the air interface resource 502. The resource manager 266 (shown in FIG. 2) may manage or schedule DL transmissions from the base stations 120 to one or more user equipment 110. The resource manager 266 may also determine DL transmissions to be canceled, a type or amount of information (e.g., data or control information) to be communicated (e.g., transmitted) by the user equipment 110. For example, the resource manager 266 can determine that a user equipment 110 requests a particular ongoing or scheduled DL transmission to be canceled (e.g., based on a DTCR, as described herein), or transmit a different respective amount of information. The resource manager 266 then allocates one or more resource blocks 510 to each user equipment 110 based on the determined amount of information or, after receiving the DTCR, reallocates one or more resource blocks 510 to another DL transmission for a same or different equipment 110. The air interface resource 502 can also be used to transmit the DTCR, as described herein.

Additionally, or in the alternative to block-level resource grants, the resource manager 266 may allocate resource units at an element-level. Thus, the resource manager 266 may allocate one or more resource elements 520 or individual subcarriers to different user equipment 110. By so doing, one resource block 510 can be allocated to facilitate network access for multiple user equipment 110. Accordingly, the resource manager 266 may allocate, at various granularities, one or up to all subcarriers or resource elements 520 of a resource block 510 to one user equipment 110 or divided across multiple user equipment 110, thereby enabling higher network utilization or increased spectrum efficiency. Additionally or alternatively, the resource manager 266 may, in response to the DTCR described herein, cancel an ongoing or scheduled DL transmission and reallocate or change the allocation of air interface resources for a carrier, subcarrier, or carrier band.

The resource manager 266 can therefore allocate air interface resource 502 by resource unit 504, resource block 510, frequency carrier, time interval, resource element 520, frequency subcarrier, time subinterval, symbol, spreading code, some combination thereof, and so forth. Based on respective allocations of resource units 504, the resource manager 266 can transmit respective messages to the multiple user equipment 110, indicating the respective allocation of resource units 504 to each user equipment 110. Each message may enable a respective user equipment 110 to queue the information or configure the LTE transceiver 206, the 5G NR transceiver 208, or both to communicate using the allocated resource units 504 of the air interface resource 502.

User-Equipment-Initiated Cancelation of a Downlink Transmission

In aspects, the user equipment 110 can detect a trigger event, such as an RF signal that may interfere with a DL transmission, or a value of a thermal or battery-capacity parameter exceeding or falling below a threshold. In response to the trigger event, the user equipment 110 can generate a downlink transmission cancelation request (DTCR), which includes a request to cancel all or part of an ongoing or scheduled DL transmission, and transmit the DTCR to the base stations 120 (e.g., to the base station 121, which is providing the DL transmission to the user equipment 110).

In some implementations, the DTCR may include additional information related to either or both of the user equipment 110 or the DL transmission that is to be canceled. For example, the DTCR may include a user equipment identifier, such as a radio network temporary identifier (RNTI), a globally unique temporary identifier (5G-GUTI), a permanent equipment identifier (PEI), a subscriber or subscription identity (e.g., a 5G subscription permanent identifier (SUPI)), or another identifier that uniquely identifies the user equipment 110. Similarly, the DTCR may include a transmission identifier that identifies the DL transmission that is to be canceled. For example, the DL transmission itself may include an identifier, such as an identity (ID) field in a physical downlink control channel (PDCCH) DL transmission, and the DTCR can include the ID field data to identify the specific DL transmission that is to be canceled. These techniques help ensure that the proper DL transmission is canceled and that only an authorized user equipment 110 can request a cancelation.

In some implementations, the DTCR may include, or serve as, a negative acknowledgement (NACK) for a corresponding downlink on a Physical Downlink Shared Channel (PDSCH). In this way, the DTCR may save some network resources (e.g., time and frequency resources) that would have been used to transmit a separate NACK.

Further, in some implementations, the DTCR may include a layer or beam identifier to describe or specify a particular DL layer or beam direction of the DL transmission that is to be canceled. For example, in a MIMO transmission, a particular beam may correspond to a lower modulation and coding scheme (MCS) index value, and another beam may correspond to a higher MCS index value. In this case, the DTCR may include a cancelation request for only the DL transmission layer corresponding to the beam or beams with the higher MCS index value (e.g., above a threshold MCS index value) because beams using a higher MCS are more sensitive to RF interference. In this way, the DTCR can be used to cancel a portion of a DL transmission while maintaining the DL transmission for other beams and layers. Thus, the user equipment may be in an engaged or disengaged mode after the DL transmission is canceled (e.g., canceling the DL transmission using the DTCR does not require the user equipment to enter the idle state). Further, the user equipment (or the base station) can determine whether the user equipment is in the engaged or disengaged mode when the trigger event is detected. Based on the trigger event or the cancelation of all or part of the downlink transmission, the user equipment can remain in the determined mode (e.g., remain in a connected or inactive mode) or enter a different mode (e.g., transition from connected to inactive, inactive to connected, or to and from other modes).

The user equipment 110 can transmit the DTCR to the base station 121 using any of a variety of transmission or signaling techniques. For example, the user equipment 110 (using, for example, the DTC manager 222) can transmit the DTCR using a grantless physical uplink shared channel (PUSCH) transmission. In some cases, the DTCR may be transmitted using the grantless PUSCH transmission using predetermined time and frequency resources. These predetermined resources can be included in the DL transmission using, for example, a downlink control information (DCI) element. In this way, a DL transmission (with DCI in the PDCCH), can include particular predetermined time and frequency resources that can be used to transmit the DTCR. Further, as noted, the grantless PUSCH transmission may contain a user equipment identifier to prevent a request from an unauthorized user equipment being used to cancel the DL transmission.

In some implementations, the DTCR can be transmitted to the base station 121 using control channel signaling. For example, when the DL transmission to be canceled is a semi-static grant using radio resource control (RRC) signaling, the DTC manager 222 can transmit the DTCR using RRC signaling. Further, predetermined time and frequency resources may be identified in the semi-static grant of the DL transmission, and the DTCR can be transmitted using the predetermined time and frequency resources. In some cases, the DTC manager 222 can transmit the DTCR to the base station 121 using a physical uplink control channel (PUCCH) operation, rather than using a data channel.

In some implementations, user equipment 110 may transmit the DTCR to another base station (e.g., the base station 122), which relays the DTCR to the base station 121. The base station 121 can then cancel the DL transmission specified in the DTCR. The base station 121 and the other base station 122 can be a same or different type of base station (e.g., a 5G NR base station or an E-UTRA base station) and may communicate using any suitable means, such as an Xn interface. Thus, the base station 121 can provide the DL transmission using a particular radio access network (RAT), such as a 5G NR downlink connection, and the user equipment 110 can transmit the DTCR to the base station using another RAT, such as an LTE uplink connection. Additionally or alternatively, the base station 121 may provide the DL transmission using a first carrier and the user equipment 110 may transmit the DTCR to the base station 121 using a second carrier. It should be noted that the methods and techniques described herein as being performed by either or both of the user equipment 110 or the base stations 120 (e.g., the base station 121) may be performed using applications or modules described herein, such as either or both of the DTC manager 222 or the resource manager 266.

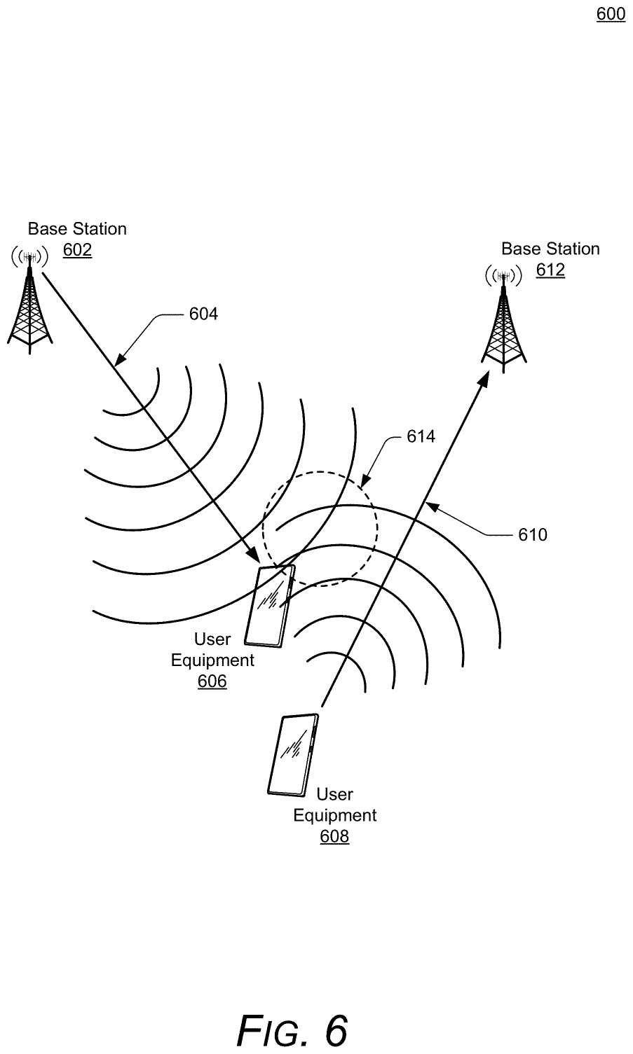

Consider FIG. 6, which illustrates an example environment 600 in which the described techniques and systems can detect RF interference and cancel a DL transmission affected by the RF interference. In FIG. 6, a base station 602 (e.g., the base station 121) transmits a DL transmission 604 to a user equipment 606 (e.g., the user equipment 110). At about the same time, a nearby user equipment 608 transmits an UL transmission 610 to another base station 612 (e.g., the base station 122). Assume for this example that the UL transmission 610 is on the same frequency (or a nearby frequency in a same frequency band) as the DL transmission 604. As shown in FIG. 6, the uplink transmission 610, in this case, is interfering with the DL transmission 604 to the user equipment 606, as indicated with a dashed-circle 614. In the example 600, the user equipment 606 may be able to detect the signal causing the interference 614 (e.g., using the interference manager 220) and determine that the interference 614 is a trigger event. In some cases, the interference manager 220 may be able to determine that the interference 614 is a trigger event by detecting an effect caused by the interference (e.g., a connection loss or a degraded performance parameter such as code word or symbol error). The user equipment 606 can then transmit a DTCR (e.g., using the DTC manager 222) to the base station 602, which can cancel, halt, or pause the DL transmission 604.

Example Methods

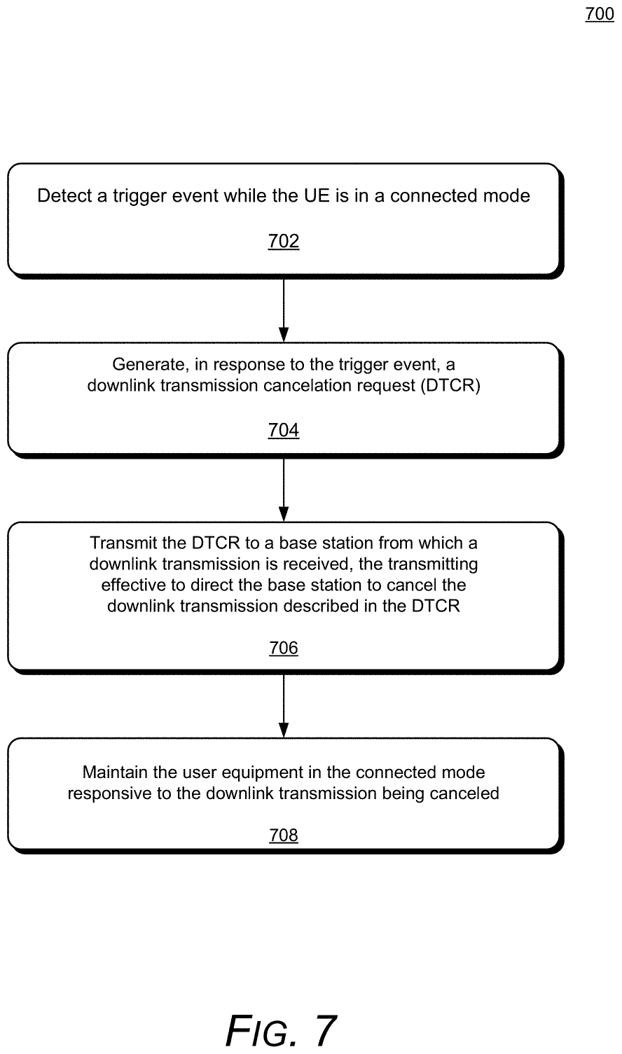

Example method 700 is described with reference to FIG. 7 in accordance with one or more aspects of user-equipment-initiated cancelation of a base station downlink transmission. The order in which the method blocks are described is not intended to be construed as a limitation, and any number of the described method blocks can be skipped or combined in any order to implement a method or an alternate method. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 7 illustrates an example method(s) 700 for user-equipment-initiated cancelation of a base station downlink transmission as generally related to techniques that allow a user equipment to cancel or suspend a DL transmission (e.g., such as by entering the idle or inactive state as described above with reference to FIG. 4). The cancelation is based at least in part on a downlink transmission cancelation request (DTCR) that is transmitted from the user equipment 110 to the base station 121 in response to an occurrence of a trigger event. The trigger event may be related to RF interference, user equipment power savings, user equipment temperature, downlink performance, or other factors.

At block 702, the user equipment detects a trigger event. Generally, the trigger event indicates a condition or state of the user equipment that may be addressed by canceling an ongoing or scheduled (granted) DL transmission. For example, the trigger event may be related to safety, power-consumption, or performance factors. In some cases, for example, the trigger event may occur when the user equipment 110 detects RF interference that causes an RF noise level to exceed a noise threshold or an SNR/SANR of the DL transmission that falls below a threshold value (e.g., a SNR or SANR of less than 15 dB, 20 dB, or 25 dB). Additionally or alternatively, the trigger event may occur if a remaining battery-capacity level falls below a capacity threshold. The threshold may be based on a percentage of battery capacity remaining (e.g., 40, 25, or 15 percent of battery capacity) or on an estimated or calculated duration of remaining battery life (e.g., 90, 60, or 30 minutes). Other trigger events include a thermal parameter exceeding a thermal threshold, such as a particular temperature, a duration operating at a temperature above a temperature threshold, or a percentage of a maximum safe operating temperature of the user equipment 110 (e.g., 90, 75, or 60 percent). As used herein, the term “thermal parameter” refers to any metric that is based on, or otherwise relating to, the temperature of the user equipment 110 or a component of the user equipment 110.

The user equipment 110 may detect the trigger event in any of a variety of manners. For example, the user equipment 110 may communicate with any one or more of the thermal manager 216, the power manager 218, or the interference manager 220 to detect thermal-, power-, or RF interference-based trigger events. The trigger event may also be a weighted combination of various inputs (e.g., signals from the thermal manager 216, the power manager 218, the interference manager 220, and potentially other elements in the user equipment 110 such as one or more of the transceivers 206, 208). The UE may detect the trigger event while the UE is any of a variety of modes or states (e.g., a connected mode or an inactive mode, as described with reference to FIG. 4).

At block 704, in response to the trigger event, the user equipment generates the DTCR. For example, when the user equipment 110 detects the trigger event (e.g., that the RF noise level exceeds the noise threshold), the user equipment 110 generates a DTCR that can be used to cancel the DL transmission affected by or related to the trigger event.

Generally, the DTCR is a request to cancel or suspend a DL transmission from the base station 121. The DTCR includes a downlink transmission identification field that corresponds to the downlink transmission, which may be a currently ongoing downlink transmission or a scheduled downlink transmission. More specifically, the DTCR may include information that specifies a particular DL transmission, such as ID field data from a PDCCH DL transmission (e.g., the DTCR may include a downlink transmission identification field value that corresponds to the downlink transmission). The DTCR may also include a layer identification of the DL transmission layer to be canceled or a beam identification of a particular beam of the DL transmission that is to be canceled. The DTCR may also include information that can be used to identify the user equipment 110, as described above (e.g., an RNTI, 5G-GUTI, PEI, SUPI, or another identifier). In some implementations, the DTCR may also include, or serve as, the NACK for a corresponding downlink on the PDSCH. In this way, the DTCR can be used to help ensure that the proper DL transmission is canceled, that only an authorized user equipment 110 can request a cancelation, and preserve network resources (e.g., time and frequency resources) that would have been used to transmit a separate NACK.

At block 706, the user equipment transmits the DTCR to the base station that is providing the DL transmission, which directs the base station to cancel or suspend the DL transmission described in the DTCR. For example, the DTCR may direct the base station to cancel or suspend all the downlink transmission or only parts (e.g., one or more beams, one or more layers, or a combination of beams and layers).

At block 708, in response to the cancelation of all or part of the downlink transmission, the user equipment may remain or be maintained in the connected mode. In other implementations, the UE may enter an inactive mode (or remain in or enter another mode). For example, the user equipment 110 can exit a connected mode and enter an inactive mode in response to cancelation of all or part of the downlink transmission. In other cases, the user equipment 110 may instead remain in the connected mode (e.g., when less than all of the downlink transmission is canceled, such as when only a downlink transmission layer or a downlink transmission beam is canceled).

The transmitting of the DTCR is effective to direct the base station to cancel the downlink transmission that is described in the DTCR. In other words, the DTCR instructs the base station to cancel the downlink transmission that is specified by the DTCR. Upon receiving the DTCR, the base station identifies a particular downlink transmission (e.g., using the downlink transmission identification field value that is included in the DTCR), and cancels that downlink transmission.

For example, the user equipment 110 (or the DTC manager 222) may transmit the DTCR to the base station 121, from which the current, ongoing DL transmission is being provided (or from which a granted and scheduled DL transmission will be provided). The user equipment 110 may transmit the DTCR to the base station 121 in a variety of manners. For example, the user equipment 110 may transmit the DTCR using a grantless PUSCH transmission. In some cases, the DTCR may be transmitted using the grantless PUSCH transmission using predetermined time and frequency resources, as described above.

In some implementations, the DTCR can be transmitted to the base station 121 using control channel signaling. For example, when the DL transmission to be canceled is a semi-static grant using RRC signaling, the user equipment 110 (or the DTC manager 222) can transmit the DTCR using RRC signaling. Further, predetermined time and frequency resources may be identified in the semi-static grant of the DL transmission, and the DTCR can be transmitted using the predetermined time and frequency resources. In some cases, the user equipment 110 can transmit the DTCR to the base station 121 using a PUCCH operation, as described above.

Additionally or alternatively, the user equipment 110 may transmit the DTCR to the base station 121 using any of a variety of suitable techniques. For example, the user equipment 110 may transmit the DTCR to the master or serving base station using a wireless link, such as an LTE connection, a 5G NR connection, and so forth (e.g., using the wireless link 131). In other implementations, the user equipment 110 may transmit the DTCR to the master or serving base station using another base station, using an inter-base station interface. For example, the base station 121 that provides DL transmission may be a 5G NR base station that includes an inter-base station interface 268, such as an Xn interface. The user equipment 110 may transmit the DTCR to the other base station (e.g., the other base station 122), which relays the DTCR to the base station 121. The base station 121 then cancels the DL transmission specified in the DTCR transmitted to the base station 122. The Xn interface can allow the 5G NR base station 121 to receive the DTCR from the base station 122, which may be any suitable base station 120 (e.g., another 5G NR base station or a 3GPP LTE base station).

Because the user equipment 110 often uses less power when using a narrower-band connection (such as the connection to the E-UTRA base station 122), this type of dual-connectivity implementation may be advantageous in a situation in which the trigger event occurs while the user equipment 110 already has been granted uplink to the E-UTRA base station. Further, in some implementations, the base station 121 may provide the DL transmission to the user equipment 110 using a particular carrier or sub-carrier, and the user equipment 110 may transmit the DTCR to the base station 121 on a same or different carrier or sub-carrier.

Several examples of user-equipment-initiated cancelation of a base station downlink transmission are described in the following paragraphs.

### EXAMPLE 1

A method for canceling a downlink transmission for a user equipment, UE, the method comprising: detecting, by the UE while in a connected mode, a trigger event; in response to the trigger event, generating a downlink transmission cancelation request, DTCR, the DTCR including a downlink transmission identification field value that corresponds to the downlink transmission; transmitting the DTCR to a base station from which the downlink transmission is received, the transmitting being effective to direct the base station to cancel the downlink transmission that is described in the DTCR; maintaining the UE in the connected mode responsive to the downlink transmission being canceled.

### EXAMPLE 2

The method of example 1, wherein the DTCR includes one or more of: a downlink transmission layer identification of the downlink transmission layer to be canceled; or a beam identification of a downlink transmission beam to be canceled.

### EXAMPLE 3

The method of example 2, further comprising: transmitting a second DTCR to the base station from which the downlink transmission is received, the transmitting being effective to direct the base station to cancel the downlink transmission layer or the downlink transmission beam that is described in the DTCR; and entering, by the UE, an inactive mode responsive to the downlink transmission layer or the downlink transmission beam being canceled.

### EXAMPLE 4

The method of any of the preceding examples, wherein: the downlink transmission is a physical downlink control channel, PDCCH, downlink transmission; and the identification field value is a value in an identity field included in the PDCCH downlink transmission.

### EXAMPLE 5

The method of any of the preceding examples, wherein the downlink transmission is: a currently ongoing downlink transmission; or a scheduled downlink transmission that is already granted.

### EXAMPLE 6

The method of any of the preceding examples, wherein the transmitting the DTCR to the base station further comprises: transmitting the DTCR to the base station using a grantless physical uplink shared channel (PUSCH) transmission.

### EXAMPLE 7

The method of example 4, wherein the DTCR is transmitted using the grantless PUSCH transmission using predetermined time and frequency resources, the predetermined time and frequency resources identified in the downlink transmission using downlink control information (DCI).

### EXAMPLE 8

The method of any of the preceding examples, wherein: the downlink transmission is a semi-static grant assigned using radio resource control (RRC) signaling; and transmitting the DTCR to the base station further comprises: transmitting the DTCR to the base station using the RRC signaling.

### EXAMPLE 9

The method of example 8, wherein the transmitting the DTCR to the base station using the RRC signaling comprises: using predetermined time and frequency resources, the predetermined time and frequency resources identified in the semi-static grant of the downlink transmission.

### EXAMPLE 10

The method of any of examples 1-4, wherein the transmitting the DTCR to the base station further comprises: transmitting the DTCR to the base station using a physical uplink control channel (PUCCH) operation.

### EXAMPLE 11

The method of any of the preceding examples, wherein the detecting, by the UE, the trigger event comprises detecting one or more of: a signal-to-noise ratio (SNR) or a signal-to-artificial-noise ratio (SANR) exceeding an interference threshold; or a remaining battery-capacity level falling below a capacity threshold; or a value of a thermal parameter of the UE exceeding a thermal threshold.

### EXAMPLE 12

The method of any of the preceding examples, wherein the DTCR includes a UE identity.

### EXAMPLE 13

The method of any of the preceding examples, wherein: the downlink transmission is received from the base station using a first carrier; and the DTCR is transmitted to the base station using a second carrier.

### EXAMPLE 14

The method of any of the preceding examples, wherein: the downlink transmission is received from the base station using a first radio access network (RAT); and the DTCR is transmitted to the base station using a second RAT.

### EXAMPLE 15

A user equipment, UE, the UE comprising: a radio frequency transceiver; and a processor and memory system to perform any of the methods of any of the preceding examples.

### EXAMPLE 16

A computer-readable medium comprising instructions that, when executed by a processor, cause a user equipment incorporating the processor to perform any of the methods of any of claims 1 to 14.

### EXAMPLE 17

A method for canceling a downlink transmission for a user equipment (UE), comprising: detecting, by the UE, a trigger event; in response to the trigger event, generating a downlink transmission cancelation request (DTCR); and transmitting the DTCR to a base station that is providing the downlink transmission, the transmitting being effective to cause the base station to cancel the downlink transmission that is described in the DTCR.

### EXAMPLE 18

The method of example 17, wherein the downlink transmission is: a currently ongoing downlink transmission; or a scheduled downlink transmission that is already granted.

### EXAMPLE 19

The method of example 17, wherein the transmitting the DTCR to the base station further comprises: transmitting the DTCR to the base station using a grantless physical uplink shared channel (PUSCH) transmission.

### EXAMPLE 20

The method of example 19, wherein the DTCR is transmitted using the grantless PUSCH transmission using predetermined time and frequency resources, the predetermined time and frequency resources identified in the downlink transmission using downlink control information (DCI).

### EXAMPLE 21

The method of example 17, wherein: the downlink transmission is a semi-static grant assigned using radio resource control (RRC) signaling; and transmitting the DTCR to the base station further comprises: transmitting the DTCR to the base station using the RRC signaling.

### EXAMPLE 22

The method of example 21, wherein the transmitting the DTCR to the base station using the RRC signaling comprises: using predetermined time and frequency resources, the predetermined time and frequency resources identified in the semi-static grant of the downlink transmission.

### EXAMPLE 23

The method of example 17, wherein the transmitting the DTCR to the base station further comprises: transmitting the DTCR to the base station using a physical uplink control channel (PUCCH) operation.

### EXAMPLE 24

The method of example 17, wherein the detecting, by the UE, the trigger event comprises detecting one or more of: a signal-to-noise ratio (SNR) or a signal-to-artificial-noise ratio (SANR) exceeding an interference threshold; or a remaining battery-capacity level falling below a capacity threshold; or a value of a thermal parameter of the UE exceeding a thermal threshold.

### EXAMPLE 25

A user equipment (UE), comprising: a radio frequency (RF) transceiver; and a processor and memory system to implement a downlink transmission cancelation (DTC) manager application configured to: detect a trigger event; generate, in response to the trigger event, a downlink transmission cancelation request (DTCR); transmit, using the RF transceiver, the DTCR to a base station that is providing the downlink transmission, the transmitting being effective to cause the base station to cancel the downlink transmission that is described in the DTCR.

### EXAMPLE 26

The UE of example 25, wherein the downlink transmission is: a currently ongoing downlink transmission; or a scheduled downlink transmission that is already granted.

### EXAMPLE 27

The UE of example 25, wherein the downlink transmission cancelation (DTC) manager application is further configured to: transmit the DTCR to the base station using a grantless physical uplink shared channel (PUSCH) transmission.

### EXAMPLE 28

The UE of example 25, wherein the DTCR includes a UE identity.

### EXAMPLE 29

The UE of example 25, wherein: the downlink transmission is a semi-static grant using radio resource control (RRC) signaling; and the downlink transmission cancelation (DTC) manager application is further configured to: transmit the DTCR to the base station using the RRC signaling.

### EXAMPLE 30

The UE of example 25, wherein the downlink transmission cancelation (DTC) manager application is further configured to: transmit the DTCR to the base station using a physical uplink control channel (PUCCH) operation.

### EXAMPLE 31

The UE of example 25, wherein: the downlink transmission includes an identification (ID) field; and the DTCR includes the ID field of the downlink transmission to be canceled.

### EXAMPLE 32

The UE of example 25, wherein the DTCR includes one or more of: a downlink transmission layer identification of the downlink transmission layer to be canceled; or a beam identification of the downlink transmission to be canceled.

### EXAMPLE 33

The UE of example 25, wherein the DTCR includes a negative acknowledgement (NACK) for a corresponding downlink physical downlink shared channel (PDSCH).

### EXAMPLE 34

The UE of example 25, wherein the trigger event is one or more of: a signal-to-noise ratio (SNR) or a signal-to-artificial-noise ratio (SANR) falling below a threshold value; or a remaining battery-capacity level falling below a capacity threshold; or a value of a thermal parameter of the UE exceeding a thermal threshold.

### EXAMPLE 35

The UE of example 25, wherein: the base station provides the downlink transmission using a first carrier; and the downlink transmission cancelation (DTC) manager application is further configured to transmit the DTCR to the base station using a second carrier.

### EXAMPLE 36

The UE of example 25, wherein the base station provides the downlink transmission using a first radio access network (RAT); and the downlink transmission cancelation (DTC) manager application is further configured to transmit the DTCR to the base station using a second RAT.

### EXAMPLE 37

The method of any of the preceding examples, wherein the DTCR includes a negative acknowledgement (NACK) for a corresponding downlink physical downlink shared channel (PDSCH).

### EXAMPLE 38

A method for canceling a downlink transmission for a user equipment, UE, the method comprising: detecting, by the UE, a trigger event; in response to the trigger event, generating a downlink transmission cancelation request, DTCR, the DTCR including a downlink transmission identification field value that corresponds to the downlink transmission; transmitting the DTCR to a base station from which the downlink transmission is received, the transmitting being effective to direct the base station to cancel the downlink transmission that is described in the DTCR; and entering, by the UE, a connected mode or an inactive mode responsive to the downlink transmission being canceled.

Although aspects of user-equipment-initiated cancelation of a base station downlink transmission have been described in language specific to features and/or methods, the subject of the appended claims is not necessarily limited to the specific features or methods described. Rather, the specific features and methods are disclosed as example implementations of the user-equipment-initiated cancelation of a base station downlink transmission, and other equivalent features and methods are intended to be within the scope of the appended claims. Further, various different aspects are described, and it is to be appreciated that each described aspect can be implemented independently or in connection with one or more other described aspects.

1. A method for canceling a downlink transmission for a user equipment, UE, the method comprising:
detecting, by the UE while in a connected mode, a trigger event;
in response to the trigger event, generating a downlink transmission cancelation request (DTCR) the DTCR including a downlink transmission identification field value that corresponds to the downlink transmission, the downlink transmission being a scheduled downlink transmission that is already granted or a semi-static grant;
transmitting the DTCR to a base station from which the downlink transmission is received, the transmitting being effective to direct the base station to cancel the downlink transmission that is described in the DTCR; and
maintaining the UE in the connected mode responsive to the downlink transmission being canceled.

2. The method of claim 1, wherein the DTCR includes one or more of:
a downlink transmission layer identification of the downlink transmission layer to be canceled; or
a beam identification of a downlink transmission beam to be canceled.

3. The method of claim 2, further comprising:
transmitting a second DTCR to the base station from which the downlink transmission is received, the transmitting being effective to direct the base station to cancel the downlink transmission layer or the downlink transmission beam that is described in the DTCR; and
entering, by the UE, an inactive mode responsive to the downlink transmission layer or the downlink transmission beam being canceled.

4. The method of claim 1, wherein:
the downlink transmission is a physical downlink control channel (PDCCH) downlink transmission; and
the identification field value is a value in an identity field included in the PDCCH downlink transmission.

5. (canceled)

6. The method of claim 1, wherein the transmitting the DTCR to the base station further comprises:
transmitting the DTCR to the base station using a grantless physical uplink shared channel, PUSCH, transmission.

7. The method of claim 6, wherein the DTCR is transmitted using the grantless PUSCH transmission using predetermined time and frequency resources, the predetermined time and frequency resources identified in the downlink transmission using downlink control information, DCI.

8. The method of claim 1, wherein:
the downlink transmission is [[a]] the semi-static grant assigned using radio resource control, RRC, signaling; and
transmitting the DTCR to the base station further comprises:
transmitting the DTCR to the base station using the RRC signaling.

9. The method of claim 8, wherein the transmitting the DTCR to the base station using the RRC signaling comprises:
using predetermined time and frequency resources, the predetermined time and frequency resources identified in the semi-static grant of the downlink transmission.

10. The method of claim 1, wherein the transmitting the DTCR to the base station further comprises:
transmitting the DTCR to the base station using a physical uplink control channel, PUCCH, operation.

11. The method of claim 1, wherein the detecting, by the UE, the trigger event comprises detecting one or more of:
a signal-to-noise ratio or a signal-to-artificial-noise ratio exceeding an interference threshold;
a remaining battery-capacity level falling below a capacity threshold; or
a value of a thermal parameter of the UE exceeding a thermal threshold.

12. The method of claim 1, wherein the DTCR includes a UE identity.

13. The method of claim 1, wherein:
the downlink transmission is received from the base station using a first carrier; and
the DTCR is transmitted to the base station using a second carrier.

14. The method of claim 1, wherein:
the downlink transmission is received from the base station using a first radio access network, RAT; and
the DTCR is transmitted to the base station using a second RAT.

15. (canceled)

16. (canceled)

17. A user equipment (UE) the UE comprising:
a radio frequency transceiver;
a processor; and
a memory system comprising instructions for a downlink transmission cancelation (DTC) manager application that is configured to cause the UE to:
detect, while in a connected mode, a trigger event;
in response to the trigger event, generate a downlink transmission cancelation request, DTCR, the DTCR including a downlink transmission identification field value that corresponds to the downlink transmission, the downlink transmission being a scheduled downlink transmission that is already granted or a semi-static grant;
transmit the DTCR to a base station from which the downlink transmission is received, the transmission effective to direct the base station to cancel the downlink transmission that is described in the DTCR; and
maintain the UE in the connected mode responsive to the downlink transmission being canceled.

18. The UE of claim 17, wherein the DTCR includes one or more of:
a downlink transmission layer identification of the downlink transmission layer to be canceled; or
a beam identification of a downlink transmission beam to be canceled.

19. The UE of claim 18, wherein the DTC manager is further configured to cause the UE to:
transmit a second DTCR to the base station from which the downlink transmission is received, the transmission effective to direct the base station to cancel the downlink transmission layer or the downlink transmission beam that is described in the DTCR; and
enter an inactive mode responsive to the downlink transmission layer or the downlink transmission beam being canceled.

20. The UE of claim 17, wherein:
the downlink transmission is a physical downlink control channel, PDCCH, downlink transmission; and
the identification field value is a value in an identity field included in the PDCCH downlink transmission.

21. The UE of claim 17, wherein the trigger event comprises one or more of:
a signal-to-noise ratio or a signal-to-artificial-noise ratio exceeding an interference threshold;
a remaining battery-capacity level falling below a capacity threshold; or
a value of a thermal parameter of the UE exceeding a thermal threshold.

22. The UE of claim 17, wherein:
the downlink transmission is received from the base station using a first carrier; and
the DTCR is transmitted to the base station using a second carrier.

23. The UE of claim 17, wherein:
the downlink transmission is received from the base station using a first radio access network, RAT; and
the DTCR is transmitted to the base station using a second RAT.
